(19) United States
(12) Patent Application Publication
(10) Pub. No.: US 2026/0264556 A1
(43) Pub. Date: Sep. 10, 2026

(54) SYSTEM AND METHOD FOR DYNAMICALLY CHARGING AND DISCHARGING VEHICLES

(71) Applicant: NISSAN NORTH AMERICA, INC., Franklin, TN (US)

(72) Inventors: Aaron Isaac KANDEL, San Francisco, CA (US); Yoshinori SUZUE, Mountain View, CA (US)

(21) Appl. No.: 19/072,980

(22) Filed: Mar. 6, 2025

(51) Int. Cl. B60L 53/63; B60L 53/62; B60L 53/67; B60L 53/68; B60L 55/00; H02J 7/00

(52) U.S. Cl. CPC B60L 53/63; B60L 53/62; B60L 53/67; B60L 53/68; B60L 55/00; H02J 7/933; H02J 7/977; B60L 2240/545

(57) ABSTRACT

A system for managing at least one of charging and discharging of a plurality of vehicles interfacing with a demand source and a power grid is provided. The system includes at least one charging station and at least one controller. The charging station is configured to supply power to each of the plurality of vehicles at specified times. The controller is configured to control at least one of charging and discharging of the vehicles by the at least one charging station at the specified times. The controller is configured to control the at least one of charging and discharging of the plurality of vehicles based on a power demand of the demand source, a state of charge of each of the plurality of vehicles at a first time, and at least one of a relative departure probability and a relative arrival probability of each of the plurality of vehicles.

### BACKGROUND

### Field of the Invention

The present disclosure generally relates to a system for dynamically managing at least one of the charging and discharging of a plurality of vehicles interfacing with a demand source and a power grid, and a process for managing the at least one of charging and discharging of the plurality of vehicles using the system.

### Background Information

Vehicle grid integration systems are desirable because they allow optimal usage of power on the grid by managing the charging and discharging of electric vehicles (“EVs”) to decrease the peak power demand and save on power costs. In particular, these vehicle grid integration systems manage the scheduling of charging and discharging of various vehicles on the grid in order to use the power from the vehicles to decrease the peak power demand and, thus, the energy costs, of a system on the grid.

Vehicle grid integration systems include a demand source, such as a residential or commercial building, an industrial facility, a transportation system, an agricultural system, or another power demand source connected to the grid, and a plurality of EVs interfacing with the demand source. By controlling the charging and discharging of the EVs at specified times, the vehicle grid integration system can draw power from the demand source to charge the vehicles and discharge the vehicles to provide power to the demand source to reduce the peak power demand of the demand source and thereby save energy costs. However, there are some drawbacks with conventional vehicle grid integration systems. For example, known vehicle grid integration systems require computationally expensive optimization with expensive software licenses. Furthermore, such systems use overly basic heuristics and perform poorly even when time-varying (such as the load level functioning (“LLF”) method or the method of the company EDF Group). Therefore, further improvement is needed to develop a system of better managing the charging and discharging of EVs to decrease the peak power demand of a demand source on the grid while also ensuring the EVs have a sufficient state of charge when leaving the grid.

### SUMMARY

In order to improve the management of charging and/or discharging of EVs in a vehicle grid integration system, it has been proposed to assign vehicles categories based on their predicted behavior and schedule the charging and discharging of the vehicles by category. However, such a system requires numerical optimization in the form of approximate dynamic programming and, thus, does not present a simple dynamic heuristic and does not appear to consider time-varying predictions on a short time scale.

It has also been proposed to manage the charging/discharging of electric vehicles, the demand system, and the grid relative to demand response signals in order to balance the power charged and discharged by the plurality of power storage devices with the power supply and demand. Such a system optimizes the enrolled EV selection for demand response, modifies enrollment based on user responses, and modifies the requested amount of power based on the EV response. However, this system fails to calculate dynamic charge/discharge schedules and instead appears to focus on a macro time scale in scheduling charging and discharging of the EVs.

Therefore, further improvement is needed to develop a system and method for dynamically scheduling the charge and/or discharge of EVs interfacing with a demand source on the grid using predicted information about the EVs. In particular, it is desirable to provide a system and method for managing at least one of the charging and discharging of EVs on the grid using information that is predicted by models rather than input by a user.

It has been discovered that the peak energy demand can be decreased using power from EVs without adversely affecting the state of charge (“SOC”) of the EVs by dynamically generating a charge-discharge schedule for the EVs using predicted departure and/or arrival times. By managing the charging and/or discharging of the EVs based on departure and/or arrival times that are predicted based on models rather than user inputs, the system is able to address the peak demand on the grid using the EVs without depleting the SOC of the EV when a user wants to use the EV. Furthermore, by dynamically generating the charge-discharge schedule using relative departure and/or arrival probabilities that are updated over time, the system can more accurately determine the likelihood that each of the EVs will depart or arrive at a certain time and, thus, can better determine whether it is appropriate to charge or discharge an EV at a specified time.

In view of the state of the known technology, one aspect of the present disclosure is to provide a system for managing at least one of charging and discharging of a plurality of vehicles interfacing with a demand source and a power grid. The system includes at least one charging station and at least one controller. The at least one charging station is configured to supply power to each of the plurality of vehicles at specified times. The at least one controller is configured to control at least one of charging and discharging of the plurality of vehicles by the at least one charging station at the specified times. The at least one controller is configured to control the at least one of charging and discharging of the plurality of vehicles based on a power demand of the demand source, a state of charge of each of the plurality of vehicles at a first time, and at least one of a relative departure probability and a relative arrival probability of each of the plurality of vehicles. By using such a system to control the charging and/or discharging of the vehicles, peak demand of the demand source can be reduced using the vehicles while also ensuring that the vehicles have enough charge when they depart the facility.

Another aspect of the present disclosure is to provide a method of managing at least one of charging and discharging of a plurality of vehicles interfacing with a demand source and a power grid. The method includes providing a controller configured to control at least one of charging and discharging of the plurality of vehicles at specified times, and controlling the at least one of charging and discharging of the plurality of vehicles using the controller. The at least one of charging and discharging of the plurality of vehicles is controlled based on a power demand of the demand source, a state of charge of each of the plurality of vehicles at a first time, and at least one of a relative departure probability and a relative arrival probability of each of the plurality of vehicles.

By managing the charging and/or discharging of the EVs based on relative departure and/or arrival probabilities that are predicted based on models rather than user inputs, the system is able to address the peak demand on the grid using the EVs without depleting the SOC of the EV when a user wants to use the EV. Furthermore, by dynamically generating the charge-discharge schedule using relative departure and/or arrival probabilities that are updated over time, the system can more accurately determine the likelihood that each of the EVs will depart or arrive at a certain time and, thus, can better determine whether it is appropriate to charge or discharge an EV at a specified time.

### BRIEF DESCRIPTION OF THE DRAWINGS

Referring now to the attached drawings which form a part of this original disclosure:

FIG. 1 is a perspective view of a system for charging and discharging a plurality of vehicles according to a first embodiment;

FIG. 2 is a chart showing a building power demand over time according to a second embodiment;

FIG. 3 is a chart showing relative departure probabilities of a plurality of vehicles over time according to a third embodiment;

FIG. 4 is an illustrated flow chart showing a method of determining charging and discharging values for a plurality of vehicles according to a fourth embodiment;

FIG. 5 is an illustrated flow chart showing a method of managing charging and discharging of a plurality of vehicles based on relative departure probabilities according to a fifth embodiment;

FIG. 6a is a chart showing power demand over time for a vehicle grid integration system according to a sixth embodiment;

FIG. 6b is a chart showing states of charge over time for a plurality of vehicles in the vehicle grid integration system according to the sixth embodiment;

FIG. 6c is a chart showing relative departure probabilities over time for the vehicles in the vehicle grid integration system according to the sixth embodiment;

FIG. 7a is a chart showing power demand over time for a vehicle grid integration system according to a seventh embodiment;

FIG. 7b is a chart showing states of charge over time for a plurality of vehicles in the vehicle grid integration system according to the seventh embodiment; and

FIG. 7c is a chart showing relative departure probabilities over time for the vehicles in the vehicle grid integration system according to the seventh embodiment.

FIG. 8a is a chart showing power demand over time for a vehicle grid integration system according to an eighth embodiment;

FIG. 8b is a chart showing states of charge over time for a plurality of vehicles in the vehicle grid integration system according to the eighth embodiment; and

FIG. 8c is a chart showing relative departure probabilities over time for the vehicles in the vehicle grid integration system according to the eighth embodiment.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

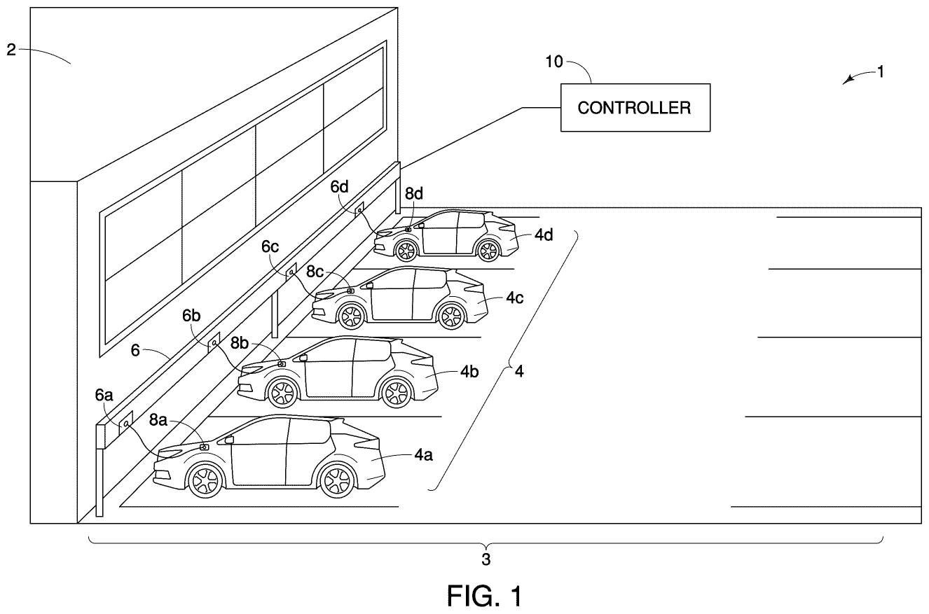

Referring initially to FIG. 1, a system 1 for charging and discharging a plurality of vehicles is illustrated according to a first embodiment. The system 1 includes a building 2 as a power demand source, a parking lot 3, a plurality of vehicles 4, a charging station 6 that includes a plurality of charging and discharging ports 6a-6d, and a controller 10.

The building 2 can be any suitable building connected to a power grid. For example, the building 2 can be an office building or a residential building. The building 2 is configured to draw power from the power grid to meet its energy demands. For example, the building 2 can be configured to draw power from the grid to run the electrical system(s), the heating system(s) and the air conditioner(s) in the building 2. The building 2 is also configured to draw power from the power grid to supply power to the charging station 6.

The system 1 also includes a parking lot 3 in which the plurality of vehicles 4 are parked. As shown in FIG. 1, the plurality of vehicles 4 includes vehicles 4a, 4b, 4c and 4d. Each of the vehicles 4a-4d is an electric vehicle that includes a bidirectional charging port 8a-8d. The charging ports 8a-8d are each configured to allow charging and discharging of the electric vehicles 4a-4d.

As shown in FIG. 1, the charging station 6 is attached to the building 2. However, it should be understood that the charging station 6 can be located in any suitable location, such as adjacent to the building 2 or within a predetermined distance from the building 2, as long as the charging station 6 is configured to draw power from and supply power to the building 2. The charging station 6 includes a plurality of bidirectional charging ports 6a, 6b, 6c and 6d that are each configured to supply power to and draw power from a vehicle connected thereto. In FIG. 1, only one charging station 6 is shown. However, it should be understood that any suitable number of charging stations can be provided in the system 1. Alternatively, the charging ports 6a may be unidirectional charging ports that are only configured to supply power to a vehicle connected thereto. The charging station 6 is controlled by the controller 10.

The controller 10 is any suitable electronic controller 10 configured to control the charging station 6 to charge and discharge electric vehicles connected to the bidirectional charging ports 6a-6d. For example, the controller 10 includes one or more processors that execute predetermined control programs to control the charging and discharging of electrical power via the charging ports 6a-6d. However, it should be understood that the controller 10 can alternatively be configured to control the charging station 6 to only charge electric vehicles connected to the charging ports 6a-6d if the charging ports are unidirectional charging ports. The processors of the electronic controller 10 include, for example, a central processing unit (“CPU”) or a micro-processing unit (“MPU”).

The processors of the electronic controller 10 can be located at separate positions. For example, some of the processors can be provided in the building 2, and the other processors can be provided in a remote server connected to the internet. In a case where the processors are located at separate positions, the processors are connected to one another via a wireless communication device in a manner allowing for communication. The electronic controller 10 can include one or more microcomputers. Thus, the term “electronic controller” as used herein refers to hardware that executes a software program, and does not include a human.

The electronic controller 10 is in communication with the charging station 6 via wired or wireless communication. For example, the electronic controller 10 can be located in or within a predetermined distance of the building 2 and can include a communication unit in wired communication with the charging station 6. The electronic controller 10 is configured to send commands to the charging station 6 to control the charging and discharging of vehicles connected to the charging ports 6a-6d of the charging station 6.

The electronic controller 10 is also in communication with the vehicles 4a-4d via the charging station 6 (i.e., the charging ports 6a-6d) or via the internet. The electronic controller 10 is configured to receive information regarding vehicle conditions from each of the vehicles 4a-4d. For example, the electronic controller 10 is configured to receive information regarding the battery, such as the battery temperature or the state of charge, for each of the vehicles 4a-4d. The electronic controller 10 is also configured to receive historical information regarding the usage of the vehicles 4a-4d, such as past arrival and departure times at the building 2 for each of the vehicles 4a-4d or past arrival and departure times from a home or residential building for each of the vehicles 4a-4d.

The electronic controller 10 is configured to control the charging and discharging of the vehicles 4a-4d connected to the charging station 6 using power from the grid. In particular, the electronic controller 10 is configured to control the charging ports 6a-6d to supply power to and draw power from each of the vehicles 4a-4d at specified times. For example, the electronic controller 10 is configured to determine whether to charge or discharge power from the vehicles 4a-4d at predetermined times based on a power demand of the building 2, a state of charge of each of the vehicles 4a-4d, and one or both of a relative departure probability and a relative arrival probability of each of the vehicles 4a-4d.

The power demand of the building 2 at a given time can either be directly detected by at least one sensor in the building 2, or the power demand can be predicted by a model trained using machine learning. For example, in order to determine the predicted power demand using a trained model, the controller 10 is configured to access historical data from the building 2, such as historical power usage patterns for the building 2.

The state of charge of each of the vehicles 4a-4d at a given time can be detected via one or more sensors located in each of the vehicles 4a-4d. The required state of charge for each of the vehicles 4a-4d at departure can be predicted based on a model trained using machine learning. For example, the model can be trained based on historical data for each of the vehicles 4a-4d, such as the distance from the building 2 to the user's residence or the vehicle usage, historical data for the building and/or location, and the required state of charge for each of the vehicles 4a-4d can be predicted based on the information in the model.

The relative departure probability of each of the vehicles 4a-4d at a given time is determined based on predicted departure time probability distributions over time for the vehicles 4a-4d. For example, the departure times for each vehicle are not input by a user and instead a probability distribution of departure times can be predicted by a model trained using machine learning. The model can be trained to predict departure time probability distributions based on historical information for the vehicle and/or the user of the vehicle., as well as historical data for the demand source Furthermore, the predicted departure time probability distributions can be updated over time, either at predetermined times or intervals, or as new vehicles arrive at the building 2 or the charging station 6.

The relative arrival probability of each of the vehicles 4a-4d at a given time is determined in a similar manner based on predicted arrival time probability distributions over time for the vehicles 4a-4d. For example, the arrival times for each vehicle are not input by a user and instead a probability distribution of arrival times can be predicted by a model trained using machine learning. The model can be trained to predict arrival time probability distributions based on historical information for the vehicle and/or the user of the vehicle, as well as historical information for the demand source. Like the predicted departure time probability distributions, the predicted arrival time probability distributions can be updated over time, either at predetermined times or time intervals or as vehicles depart from the building 2 or the charging station 6. By updating the predicted departure and arrival time probability distributions over time, the predications are dynamically generated and can better account for real-time circumstances.

The process of determining the relative departure and arrival probabilities of each of the vehicles 4a-4d will be described in further detail below. The predicted departure time probability distributions and/or the predicted arrival time probability distributions are then used to determine whether to charge or discharge each of the vehicles 4a-4d at a specific time and group the vehicles into charging and discharging groups.

Once the vehicles 4a-4d are divided into charging and discharging groups, a score is determined for each of the vehicles 4a-4d based on the power demand of the building 2, the current state of charge of the vehicles 4a-4d, the predicted required state of charge for each of the vehicles 4a-4d at departure and at least one of the relative departure probability and the relative arrival probability for each of the vehicles 4a-4d. The scores can also be based on the difference between the current power demand of the building 2 and the target or allowed threshold of the power demand of the building 2. The scores are then normalized for the vehicles in each group.

The determination of how much to charge or discharge power from each of the vehicles 4a-4d is based on the normalized scores for each of the vehicles in the charging and discharging groups. Based on the determination of whether to charge or discharge power from each of the vehicles 4a-4d at a specified time, and the determination of how much to charge or discharge, the electronic controller 10 is configured to send commands to the charging station 6, in particular the charging ports 6a-6d, to supply power to or draw power from each of the vehicles 4a-4d at the specified time.

In this embodiment, the charging station 6 is a bidirectional charging station, the charging ports 6a-6d are bidirectional charging ports, and the controller 10 is configured to control both the charging and discharging of vehicles. However, it should be understood that the features of this embodiment can also be applied to a unidirectional system in which the charging station 6 and the charging ports 6a-6d are unidirectional, and the controller 10 is configured to control only the charging of vehicles.

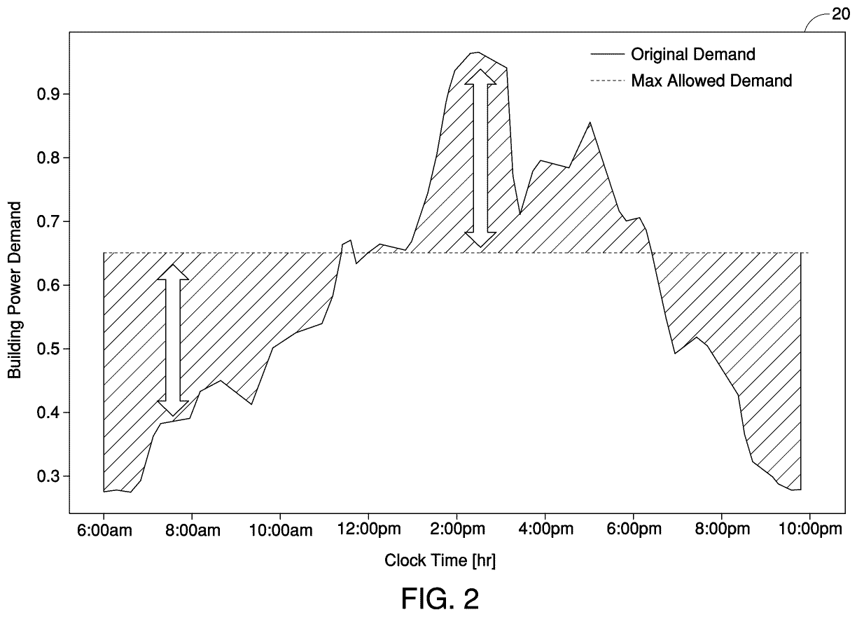

FIG. 2 shows a chart 20 of a building power demand over time according to a second embodiment. The building can be any suitable residential or commercial building, or an industrial facility. Although the chart 20 applies to a power demand of a building connected to the grid, it should be understood that the power demand over time shown in FIG. 2 can also apply to a transportation system, an agricultural system, or another power demand source connected to the grid. As shown in FIG. 2, the building power demand is lowest between the hours of approximately 6:00 am and 8:00 am, and again between approximately 6:00 pm and 8:00 pm. Around approximately 12:00 pm, the building power demand exceeds the maximum allowed demand, and the power demand remains above the maximum allowed demand until approximately 6:00 pm.

A vehicle grid integration system for controlling the charging and discharging of vehicles connected to the building can be used to reduce the peak demand of the building. In particular, by using the system described in FIG. 1 for controlling the charging and discharging of the vehicles, peak demand of the building can be reduced using the vehicles while also ensuring that the vehicles have enough charge when they depart the facility.

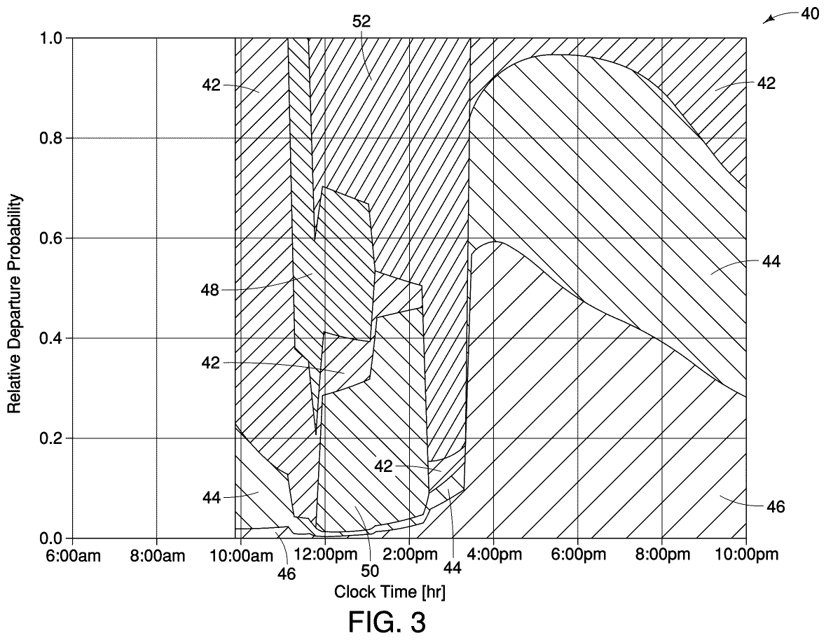

FIG. 3 is a chart 40 showing relative departure probability distributions for a plurality of vehicles over time according to a third embodiment. The plurality of vehicles are connected to a power demand source on a grid. The power demand source can be any suitable demand source, such as a residential or commercial building, an industrial facility, a transportation system, an agricultural system, or another power demand source connected to the grid.

As shown in FIG. 3, the relative departure probabilities for the vehicles range from 0.0 to 1.0, and the time ranges from 6:00 am to 10:00 pm in a single day. The plurality of vehicles includes six vehicles—vehicle 40, vehicle 42, vehicle 44, vehicle 46, vehicle 50 and vehicle 52. The relative departure probability distributions over time for each of the vehicles 40, 42, 44, 46, 50 and 52 are represented by the shaded areas in the chart 40.

As shown in FIG. 3, vehicles 42, 44 and 46 arrive at the power demand source at approximately 10:00 am. At that time, vehicle 42 has the highest relative departure probability, approximately 0.78, vehicle 44 has the second highest relative departure probability, approximately 0.2, and vehicle 46 has the lowest relative departure probability of the three vehicles—approximately 0.02. The relative departure probability of vehicle 46 remains at this low value of 0.02 until after 11:00 am, and then has a relative departure probability of nearly 0.0 around 12:00 pm.

Around approximately 11:15 am, vehicle 48 arrives at the power demand source. At that time, vehicle 48 has the highest relative departure probability, approximately 0.62, vehicle 42 has the second highest relative departure probability, approximately 0.35, vehicle 44 has the third highest relative departure probability, approximately 0.02, and vehicle 46 has the lower relative departure probability—approximately 0.01.

Around approximately 11:45 am, vehicle 52 arrives at the power demand source, and vehicle 50 arrives shortly thereafter, around approximately 11:50 am. At the arrival time of vehicle 50, vehicle 52 has the highest relative departure probability, approximately 0.4, vehicle 48 has the second highest relative departure probability, approximately 0.38, vehicle 42 has the third highest relative departure probability, approximately 0.2, vehicle 44 has the fourth highest relative departure probability, approximately 0.015, and vehicle 46 has the lower relative departure probably, approximately 0.005.

Vehicle 48 departs at approximately 1:00 pm. At that time, its relative departure probability is approximately 0.275. The relative departure probability of vehicle 52 at that time is approximately 0.325. At the same time, the relative departure probability of vehicle 42 is approximately 0.075, the relative departure probability of vehicle 50 is approximately 0.30, the relative departure probability of vehicle 44 is approximately 0.0125, and the relative departure probability of vehicle 46 is approximately 0.0125.

Vehicle 50 departs at approximately 2:30 pm. At that time, the relative departure probability of vehicle 50 is approximately 0.3. The relative departure probability of vehicle 52 at the same time is approximately 0.55. The relative departure probabilities of vehicles 42, 44 and 46 are all low—approximately 0.06, 03 and 0.06.

Around approximately 3:30 pm, vehicle 52 departs. At that time, the relative departure probability of vehicle 52 is very high, approximately 0.8. At the same time, the relative departure probabilities of vehicles 42 and 44 are approximately the same −0.05, and the relative departure probability of vehicle 46 is approximately 0.1.

Vehicles 42, 44 and 46 all depart at 10:00 pm. At that time, the relative departure probability of vehicle 42 is approximately 0.3, the relative departure probability of vehicle 44 is approximately 0.4, and the relative departure probability of vehicle 46 is approximately 0.3.

These relative departure probabilities at various times can be used to determine whether to charge or discharge one of the vehicles 42, 44, 46, 48, 50 or 52 at a given time. For example, if the determination of whether to charge or discharge is made at approximately 2:00 pm, the relative departure probabilities are high for vehicles 50 and 52 and much lower for vehicles 42, 44 and 46. Thus, a determination would be made to charge vehicles 50 and 52 and discharge vehicles 42, 44 and 46. The determination of how much to charge or discharge the vehicles would further be made based on the relative departure probability values, as well as other variables such as the battery temperature and the current SOC of the vehicles. For example, since vehicle 44 has a very low relative departure probability at 2:00 pm, a determination would be made to discharge power from vehicle 44 at 2:00 pm, but as the relative departure probability of vehicle 44 increases, for example around 4:00 or 6:00 pm, a determination would be made to charge vehicle 44 to ensure that the vehicle has a sufficient state of charge when departing the demand source.

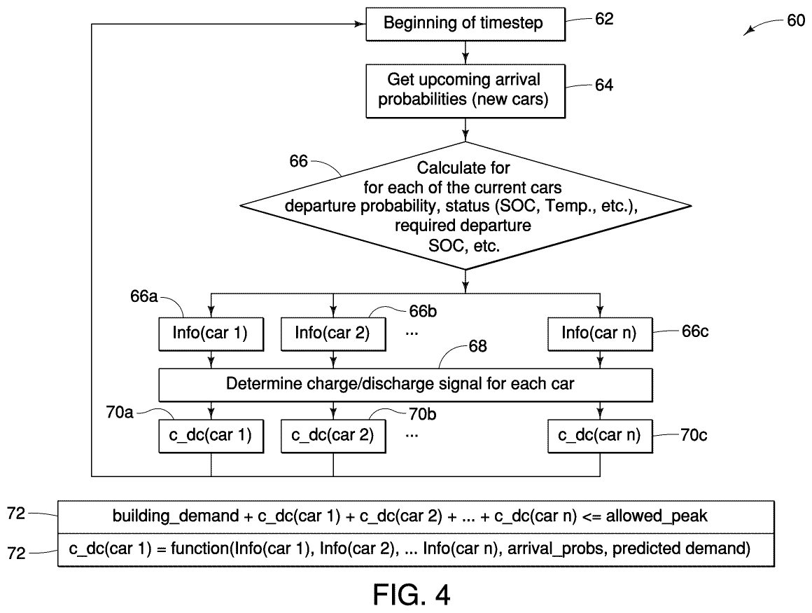

FIG. 4 shows a process 60 of determining charging and discharging values for a plurality of vehicles in accordance with a fourth embodiment. The plurality of vehicles are electric vehicles connected to a power demand source that is further connected to a grid. The power demand source can be any suitable demand source, such as a residential or commercial building, an industrial facility, a transportation system, an agricultural system, or another power demand source connected to the grid. The process 60 can be implemented by a processor such as a CPU or an MPU, and the processor can be included in an electronic controller. It should be understood that the process 60 can be implemented in a vehicle grid integration system that includes bidirectional or unidirectional chargers for electric vehicles connected to a demand source.

In Step 62, the processor determines that the process is at the beginning of a timestep. At this timestep, the processor then obtains upcoming arrival probabilities for new vehicles, if there are any, in Step 64. The arrival probabilities are based on predicted arrival time probability distributions for vehicles associated with the demand source. For example, if the demand source is an office building, the vehicles associated with the office building can be vehicles that have previously connected to the charging station of the office building, or vehicles associated with employees that work in the office building.

The processor can obtain these upcoming arrival probability distributions using a model trained with machine learning. The arrival times for each vehicle are not input by a user and instead the arrival time probability distribution over time can be predicted by the model. The model can be trained to predict arrival time probability distributions based on historical information for the vehicle, user and/or the demand source. The predicted arrival time probability distributions can be updated over time, either at predetermined times or time intervals or as vehicles depart from the demand source.

In Step 66, the processor calculates, for each of the vehicles connected to the demand source, a relative departure probability, at least one vehicle condition, and a required SOC for the vehicle upon departure. The at least one vehicle condition includes at least one of a battery temperature of the vehicle and a SOC of the battery of the vehicle.

The relative departure probability of each of the vehicles is determined based on predicted departure time probability distributions for the vehicles. For example, the departure times for each vehicle are not input by a user and instead the departure time probability distribution over time can be predicted by a model trained using machine learning. The model can be trained to predict departure time probability distributions based on historical information for the vehicle, user and/or the demand source. Furthermore, the predicted departure time probability distributions can be updated over time, either at predetermined times or intervals, or as new vehicles arrive at the demand source.

The current SOC for each of the vehicles can be detected via one or more sensors located in each of the vehicles. The required SOC for each of the vehicles at departure can be predicted based on a model trained using machine learning. For example, the model can be trained based on historical data for each of the vehicles, such as the historical vehicle usage or the distance from the demand source to the user's residence, and the required SOC at departure for each of the vehicles can be predicted based on the information in the model.

The at least one vehicle condition can be detected via a sensor in the vehicle. For example, the battery temperature of the vehicle battery can be detected via at least one temperature sensor in the vehicle. The SOC of the vehicle battery can be detected using a battery monitoring sensor or can be estimated using information from other sensors in the vehicle.

In Steps 66a, 66b and 66c, the relative departure probabilities, vehicle conditions, and required SOCs for the vehicles upon departure are used to obtain a metric (Info) or score for each vehicle (e.g., car 1, car 2 and car n). Specifically, in Step 66a, the relative departure probability, the at least one vehicle condition, and the required SOC upon departure for car 1 are each weighted or scaled in a predetermined manner to determine an overall score designated Info(car 1). Similarly, in Step 66b, the relative departure probability, the at least one vehicle condition, and the required SOC upon departure for car 2 are used to determine an overall score designated Info(car 2). In Step 66c, the relative departure probability, the at least one vehicle condition, and the required SOC upon departure for car n used to determine an overall score designated as Info(car n).

In Step 68, the information for cars 1, 2 and n is used to determine a charge or discharge signal for each of the vehicles. In particular, the processor determines for each of the vehicles (car 1, car 2, car n) whether the SOC for that vehicle is greater than the required SOC upon departure. If so, the processor determines that the vehicle can be discharged (+). If not, the processor determines that the vehicle should be charged (−). The processor then divides the vehicles into two groups—discharge and charge—based on whether the SOC is respectively greater than (+) or less than (−) the required SOC upon departure.

In Step 70, the signals for each of the vehicles are compared to each other, and the overall scores are normalized for the vehicles in each group (charge or discharge) to obtain the charge or discharge signal for each vehicle. For example, the discharge and charge signals can be determined using the formulas below:

$$Discharge signal = ( normalized score ) ⋆ ( sum ( charge signals from negative metric cars ) - allowed peak )$$

$$Charge signal = ( normalized score ) ⋆ ( sum ( charge signals from negative metric cars ) - building demand )$$

Steps 72a and 72b show the additional considerations in obtaining the charge or discharge signal for each vehicle as shown in Step 70. For example, as shown in Step 72a, the current building demand plus the charge and discharge signals must be less than or equal to the maximum allowed peak power demand of the building. As shown in Step 72b, the charge or discharge signal for each car is a function of the information used to determine the metric Info( ) for each vehicle (i.e., the relative departure probability, at least one vehicle condition, and the required SOC for the vehicle upon departure), as well as the arrival probabilities of each vehicle and the predicted building demand.

The values of the charge and discharge signals can be used by a controller to control the charging and discharging of the vehicles at the demand source. In particular, the magnitude of the charge and discharge signals determines the amount of charging or discharging of each of the vehicles by a charging station at the demand source.

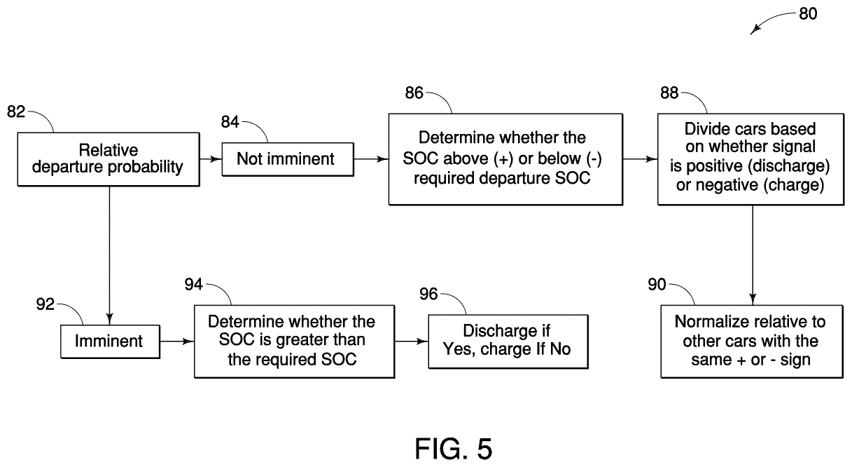

FIG. 5 shows a process 80 of managing charging and discharging of a plurality of vehicles based on relative departure probabilities in accordance with a fifth embodiment. The plurality of vehicles are electric vehicles connected to a power demand source that is further connected to a grid. The power demand source can be any suitable demand source, such as a residential or commercial building, an industrial facility, a transportation system, an agricultural system, or another power demand source connected to the grid. The process 80 can be implemented by a processor such as a CPU or an MPU, and the processor can be included in an electronic controller. It should be understood that the process 80 can be implemented in a vehicle grid integration system that includes bidirectional or unidirectional chargers for electric vehicles connected to a demand source

In Step 82, the processor determines whether a departure is imminent for each of the vehicles using a relative departure probability. The relative departure probability of each of the vehicles is determined based on predicted departure time probability distributions for the vehicles. For example, the departure times for each vehicle are not input by a user and instead the departure time probability distribution over time can be predicted by a model trained using machine learning. The model can be trained to predict departure time probability distributions based on historical information for the vehicle, the user and/or the demand source. Furthermore, the predicted departure time probability distributions can be updated over time, either at predetermined times or intervals, or as new vehicles arrive at the demand source.

The processor determines whether a departure is imminent based on whether the relative departure probability is greater than or equal to a predetermined value. The predetermined value can be any suitable value that indicates a departure is very likely to occur at a given time. For example, the predetermined value is a value greater than or equal to 0.90, preferably greater than or equal to 0.95.

In Step 84, a departure is determined to be “not imminent” for a vehicle if the relative departure probability of that vehicle is greater than the predetermined value.

In Step 86, if the departure is determined to be “not imminent,” the processor determines whether the current SOC is greater than (+) or less than (−) the required SOC upon departure and assigns a positive or negative value to the vehicle. The current SOC for each of the vehicles can be detected via one or more sensors located in each of the vehicles. The required SOC for each of the vehicles at departure can be predicted based on a model trained using machine learning. For example, the model can be trained based on historical data for each of the vehicles, such as the historical vehicle usage or the distance from the demand source to the user's residence, and the required SOC at departure for each of the vehicles can be predicted based on the information in the model.

The processor then divides the vehicles into two groups—discharge and charge—in Step 88 based on whether the SOC is respectively greater than (+) or less than (−) the required SOC upon departure and, thus, whether the vehicle has been assigned a positive or negative value.

In Step 90, the processor calculates a charge or discharge metric based on the relative departure probability, at least one vehicle condition, and a required SOC for the vehicle upon departure. The at least one vehicle condition includes at least one of a battery temperature of the vehicle and a SOC of the battery of the vehicle. The metrics are then normalized for the vehicles in each group (charge or discharge) by comparing the scores to each other to obtain a charge or discharge signal value. For example, the charge metrics are normalized for all of the vehicles in the charge group, and the discharge metrics are normalized for all of the vehicles in the discharge group.

The charge or discharge metric for each vehicle is a function of the relative departure probability, the at least one vehicle condition, and the required SOC for the vehicle upon departure, as well as the relative arrival probabilities of other vehicles and the predicted demand for the demand source.

The values of the charge and discharge signals can be used by a controller to control the charging and discharging of the vehicles at the demand source. In particular, the magnitude of the charge and discharge signals determines the amount of charging or discharging of each of the vehicles by a charging station at the demand source.

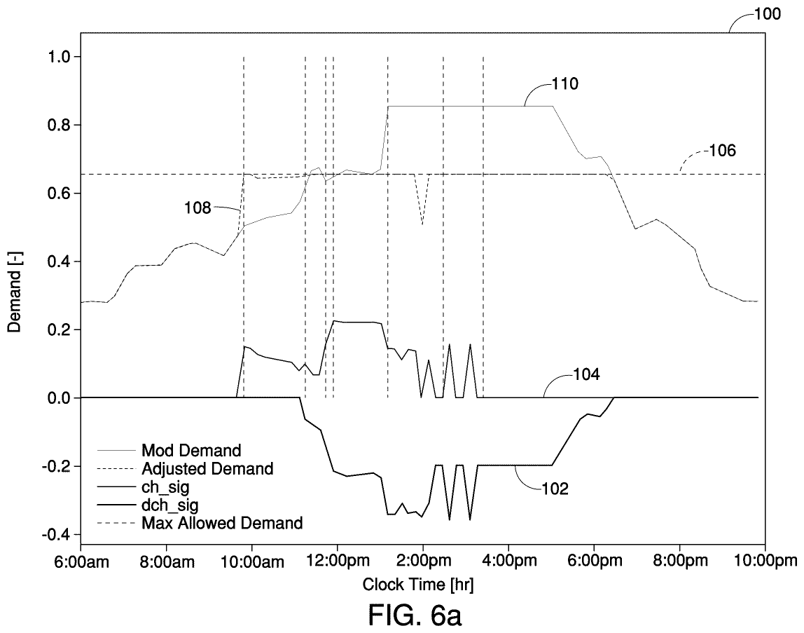

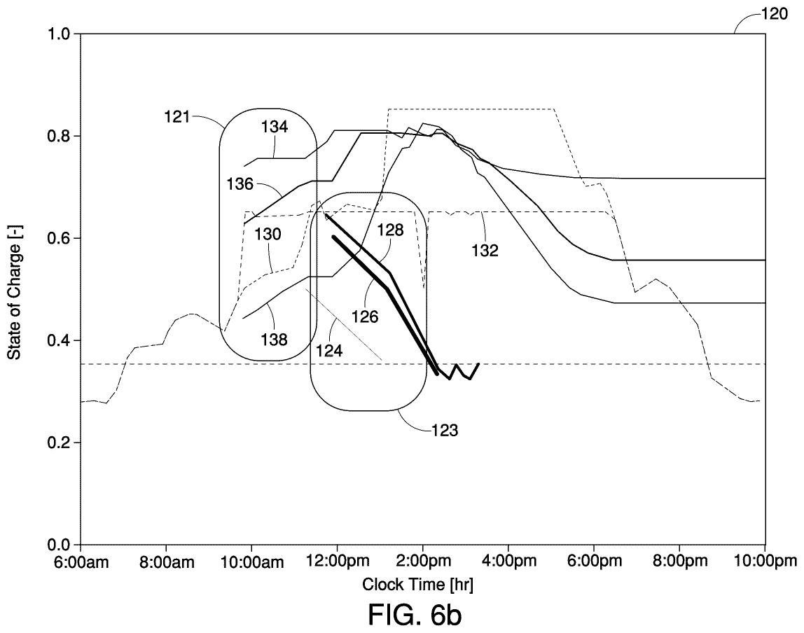

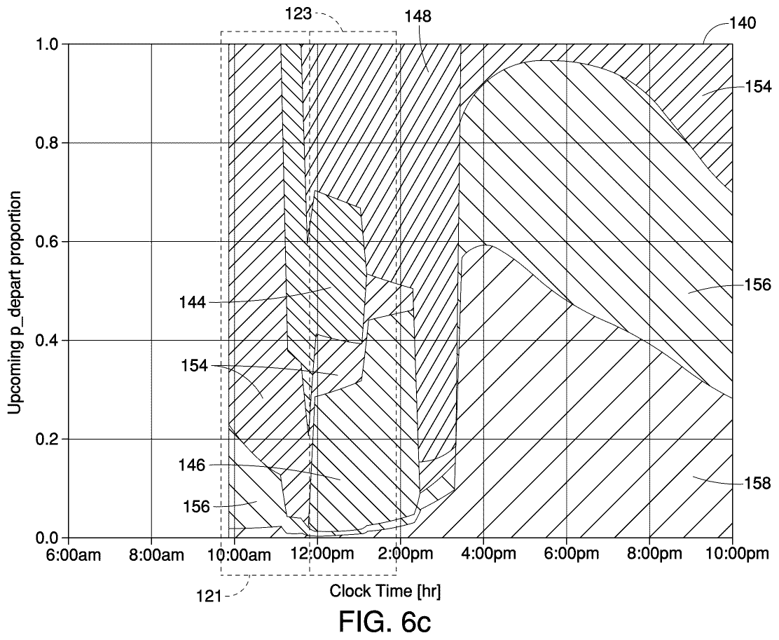

FIG. 6a is a chart 100 showing a power demand over time for a vehicle grid integration system according to a sixth embodiment. The vehicle grid integration system includes a demand source and a plurality of vehicles connected to the demand source. The demand source can be any suitable demand source connected to the power grid, such as a residential or commercial building, an industrial facility, a transportation system, an agricultural system, or another power demand source connected to the grid.

As shown in FIG. 6a, the line 102 represents the power demand of the discharge signals dch_sig of the plurality of vehicles, and line 104 represents the power demand of the charge signals ch_sig of the plurality of vehicles. Line 106 represents the maximum allowed power demand for the vehicle grid integration system. Line 108 represents the adjusted power demand of the system, and line 110 represents the modified power demand of the system if the charge and discharge signals of the vehicles were not sent to shave the peak power demand.

As shown in FIG. 6a, the modified power demand 110 of the system is highest and above the maximum allowed demand 106 between approximately 1:00 pm and 5:00 pm. Between approximately 10:00 am and 12:00 pm, the charge signals 104 for the vehicles reach a peak, which in turn increases the adjusted demand 108 and the modified demand 110. However, because the discharge signals 102 also reach a peak between approximately 12:00 pm and 2:00 pm, the power demand for the system remains the same, as shown by the adjusted demand 108 leveling off, despite a peak in the charge signals 104.

As such, FIG. 6a demonstrates that, by controlling the charging and discharging of vehicles connected to the vehicle grid integration system, the peak demand of a demand source in the system, such as a building, can be reduced. In particular, by controlling the charging and discharging of the vehicles as described in the above embodiments, peak demand of the building can be reduced using the vehicles while also ensuring that the vehicles have enough charge when they depart the facility. Although this embodiment is directed to a system in which there is bidirectional charging, it should be understood that the vehicle grid system could alternatively be one in which there is unidirectional charging.

FIG. 6b is a chart 120 showing the state of charge over time for the plurality of vehicles in the vehicle grid integration system according to the sixth embodiment. As shown in FIG. 6b, each of the vehicles 124, 126, 128, 134, 136 and 138 has a certain SOC when the vehicle arrives at the demand source. Line 130 represents the adjusted building demand, including charging and discharging, and line 132 represents building demand alone. The straight dashed line at 0.35 represents the required departure SOC. Line 130 is consistently at or below the allowed peak demand of 0.65 in FIG. 6a, meaning peak shaving is successful.

During a first time period 121, which starts at approximately 9:00 am and ends at approximately 11:00 am, vehicles 134, 136 and 138 all arrive and are charged to increase their SOCs. During a second time period 123, which starts at approximately 11:00 am and ends at approximately 2:00 pm, vehicles 124, 126 and 128 all arrive with initial SOCs over 0.5 and are discharged.

FIG. 6c is a chart 140 showing relative departure probability distributions over time for the plurality of vehicles in the vehicle grid integration system according to the sixth embodiment. The relative departure probabilities for the vehicles range from 0.0 to 1.0, and the time ranges from 6:00 am to 10:00 pm in a single day. The plurality of vehicles includes the six vehicles 124, 126, 128, 134, 136 and 138, and the relative departure probabilities for each of the vehicles 124, 126, 128, 134, 136 and 138 over time are represented by the shaded areas 144, 146, 148, 154, 156 and 158, respectively, in the chart 140.

As shown in FIGS. 6b and 6c, vehicles 134, 136 and 138 (corresponding to areas 154, 156 and 158) arrive at the power demand source of the vehicle grid integration system at approximately 10:00 am during the first time period 121. At that time, vehicle 134/154 has the highest relative departure probability, approximately 0.78, vehicle 136/156 has the second highest relative departure probability, approximately 0.2, and vehicle 138/158 has the lowest relative departure probability of the three vehicles—approximately 0.02. The relative departure probability of vehicle 138/158 remains at this low value of 0.02 until after 11:00 am, and then has a relative departure probability of nearly 0.0 around 12:00 pm.

During time period 121, as shown in FIGS. 6b and 6c, the vehicles 134. 136 and 138 are charged to increase their SOC. Thus, as shown in FIG. 6a, there is a peak in charging signals around approximately 10:00 am and continuing until about 11:00 am or 11:15 am. Because these vehicles are charged using power from the demand source, both the modified demand 110 and the adjusted demand 108 increase at this time.

Around approximately 11:15 am, another vehicle 124/144 arrives at the power demand source. At the arrival time of vehicle 124/144, vehicle 124/144 has the highest relative departure probability, approximately 0.62, vehicle 134/154 has the second highest relative departure probability, approximately 0.35, and vehicles 136/156 and 138/158 have low relative departure probabilities of approximately 0.02 and 0.01.

Around approximately 11:45 am, which corresponds to time period 123 in FIGS. 6b and 6c, vehicle 128/148 arrives at the power demand source, and vehicle 126/146 arrives shortly thereafter, around approximately 11:50 am. At the arrival time of vehicle 126/146, vehicle 128/148 has the highest relative departure probability, approximately 0.4, vehicle 124/144 has the second highest relative departure probability, approximately 0.38, vehicle 134/154 has the third highest relative departure probability, approximately 0.2, vehicle 136/156 has the fourth highest relative departure probability, approximately 0.015, and vehicle 138/158 has the lower relative departure probably, approximately 0.005.

As shown in FIG. 6a, around approximately 11:45 am, the modified demand 110 and the adjusted demand 108 of the demand source both reach the maximum allowed demand 106. Therefore, at this time, which corresponds to the start of time period 123 in FIGS. 6b and 6c, the vehicle grid integration system sends discharging signals to recently arrived vehicles 124, 126 and 128 to draw power from these vehicles and thereby shave peak power demand of the system.

As a result of the discharge signals sent to vehicles 124, 126 and 128 between approximately 11:45 am and 2:00 pm, the modified demand is significantly reduced such that the adjusted demand 108 of the system remains at or below the maximum allowed demand 106 as shown in FIG. 6a.

After approximately 3:30 pm, only vehicles 134/154, 136/156 and 138/158 remain at the demand source. As shown in FIG. 6b, these vehicles are discharged from approximately 2:00 pm until approximately 5:00 pm, at which time their SOC levels off.

As shown in FIG. 6a, because the vehicles 134/154, 136/156 and 138/158 are discharged from approximately 2:00 pm until approximately 5:00 pm, the adjusted demand 108 remains much lower than the modified demand 110. However, as shown in FIGS. 6b and 6c, because the relative departure probabilities of each of these vehicles are somewhat high after 5:00 pm, the vehicles are not discharged after 5:00 pm to ensure that they have sufficient SOC upon departure.

Therefore, the relative departure probabilities at various times, along with the vehicle SOC and predicted SOC upon departure, can be used to determine whether to charge or discharge one of the vehicles 124, 126, 128, 134, 136 or 138 at a given time. For example, if the determination of whether to charge or discharge is made at approximately 2:00 pm, the relative departure probabilities are high for vehicles 126/146 and 128/148 and much lower for vehicles 134/154, 136/156 and 138/158. Thus, a determination would be made to either charge or not discharge vehicles 126/146 and 128/148 (depending on whether their current SOC is above or below the required SOC upon departure) and to discharge vehicles 134/154, 136/156 and 138/158. The determination of how much to charge or discharge the vehicles would further be made based on the relative departure probability values. For example, since vehicle 136/156 has a very low relative departure probability at 2:00 pm, a determination would be made to discharge power from vehicle 136/156 at 2:00 pm, but as the relative departure probability of vehicle 136/156 increases, for example around 4:00 or 6:00 pm, a determination would be made to stop discharging power from vehicle 136/156 to ensure that the vehicle has a sufficient state of charge when departing the demand source.

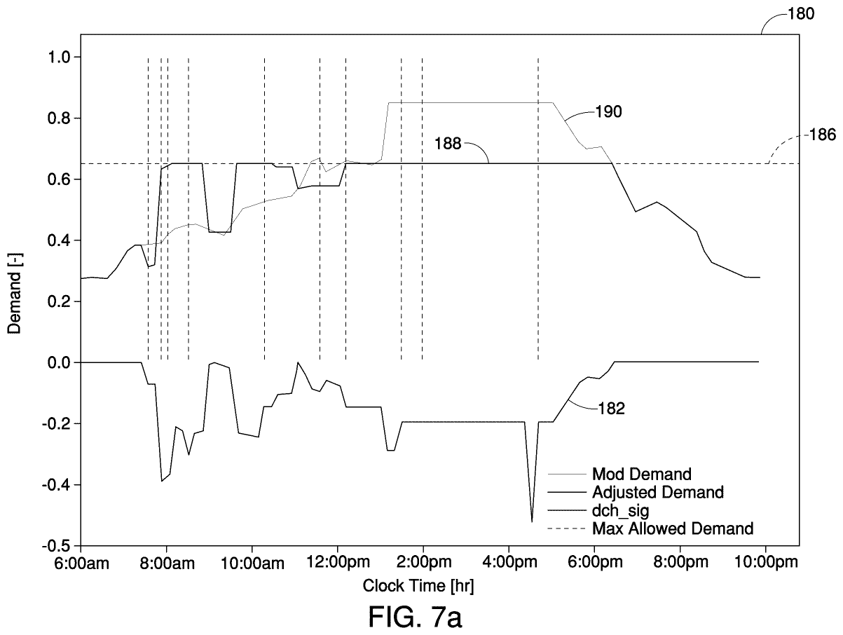

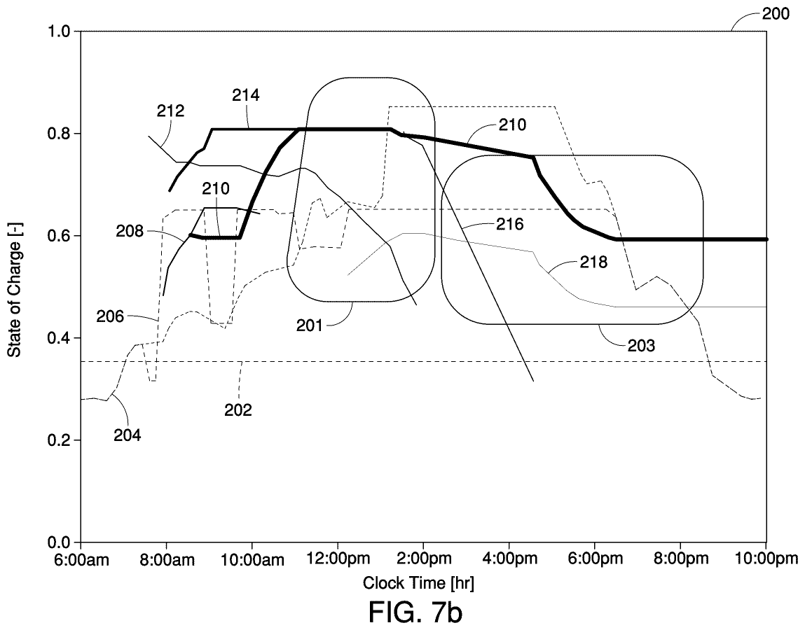

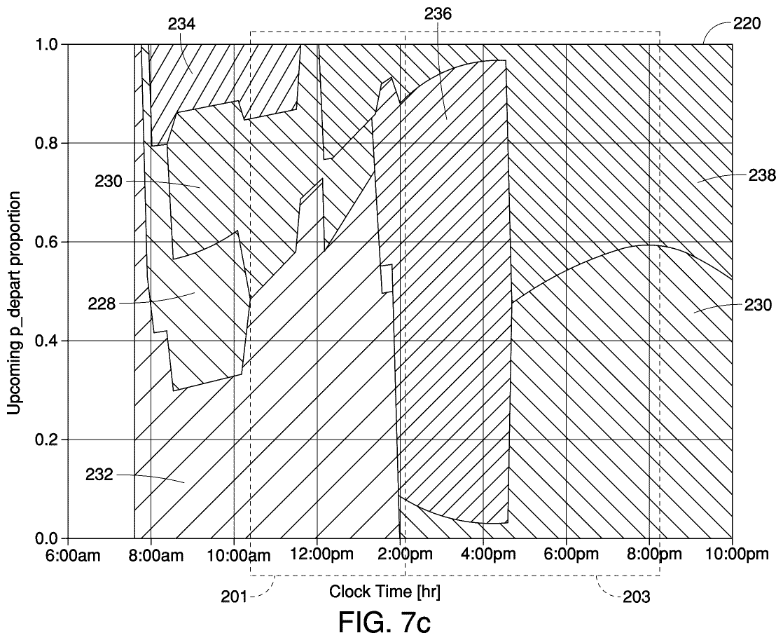

FIG. 7a is a chart 180 showing a power demand over time for a vehicle grid integration system according to a seventh embodiment. The vehicle grid integration system includes a demand source and a plurality of vehicles connected to the demand source. The demand source can be any suitable demand source connected to the power grid, such as a residential or commercial building, an industrial facility, a transportation system, an agricultural system, or another power demand source connected to the grid. Although this embodiment is directed to a system in which there is bidirectional charging, it should be understood that the vehicle grid system could alternatively be one in which there is unidirectional charging.

As shown in FIG. 7a, the line 182 represents the power demand of the discharge signals dch_sig of the plurality of vehicles. Line 186 represents the maximum allowed power demand for the vehicle grid integration system. Line 188 represents the adjusted power demand of the system, and line 190 represents the modified power demand of the system if the discharge signals of the vehicles were not sent to shave the peak power demand.

As shown in FIG. 7a, the modified power demand 190 of the system is highest and above the maximum allowed demand 186 between approximately 1:00 pm and 5:00 pm. Between approximately 1:00 pm and 5:00 pm, the discharge signals 182 for the vehicles reach a peak, which in turn keeps the adjusted demand 188 level despite the modified demand 190 increasing above the maximum allowed demand 186. Thus, the power demand for the vehicle grid integration system remains the same, despite a peak in the modified demand 190.

FIG. 7a therefore demonstrates that, by controlling the discharging of vehicles connected to the vehicle grid integration system, the peak demand of a demand source in the system, such as a building, can be reduced. In particular, by controlling the charging and/or discharging of the vehicles as described in the above embodiments, peak demand of the building can be reduced using the vehicles while also ensuring that the vehicles have enough charge when they depart the facility.

FIG. 7b is a chart 200 showing the state of charge over time for the plurality of vehicles in the vehicle grid integration system according to the seventh embodiment. As shown in FIG. 7b, each of the vehicles 208, 210, 212, 214, 216 and 218 has a certain SOC when the vehicle arrives at the demand source. Line 204 represents the building demand alone, and line 206 represents the adjusted building demand, including charging and discharging. Line 202 represents the required departure SOC. Line 206 is consistently at or below the allowed peak demand of 0.65 in FIG. 7a, meaning peak shaving is successful.

During a first time period 201, which starts at approximately 11:00 am and ends at approximately 2:00 pm, vehicle 212 is discharged, vehicle 218 arrives and is charged to a SOC of approximately 0.6 before discharging at approximately 1:00 pm, and vehicles 210, 214 and 216 are all discharged starting at approximately 1:00 pm.

During a second time period 203, which runs from approximately 2:00 pm until approximately 8:00 pm, vehicle 216 is discharged to a SOC of approximately 0.3 before departing around 4:30 pm. Once vehicle 216 departs at approximately 4:30 pm, vehicles 210 and 218 are discharged until approximately 6:30 pm, when their SOCs level off.

FIG. 7c is a chart 220 showing relative departure probabilities over time for the plurality of vehicles in the vehicle grid integration system according to the seventh embodiment. The relative departure probabilities for the vehicles range from 0.0 to 1.0, and the time ranges from 6:00 am to 10:00 pm in a single day. The relative departure probabilities for each of the vehicles 208, 210, 212, 214, 216 and 218 over time are represented by the shaded areas 228, 230, 232, 234, 236 and 238, respectively, in the chart 220.

As shown in FIGS. 7b and 7c, vehicles 208, 210, 212 and 214 (corresponding to areas 228, 230, 232 and 234) arrive at the power demand source of the vehicle grid integration system between approximately 7:30 am and 8:30 am. At the start of the first time period 201, around approximately 10:30 am, vehicle 208/228 departs. At that time, vehicle 212/232 has the highest relative departure probability, approximately 0.50, vehicle 210/230 has a relative departure probability of 0.35, and vehicle 214/234 has the lowest relative departure probability of the three vehicles—approximately 0.15.

During time period 201, as shown in FIGS. 7b and 7c, vehicle 214/234 is discharged a very small amount until it departs at approximately 11:30 am, so its SOC remains approximately the same, around 0.8, until departure. Vehicle 210/230 is also discharged a very small amount at the beginning of time period 201, but around 1:30 pm, it is discharged more noticeably to reduce the SOC from about 0.8 to about 0.78.

In contrast to vehicles 214/234 and 210/230, vehicle 212/232 is discharged continuously and a significant amount during the time period 201, from a SOC of approximately 0.7 at the beginning of time period 201 to a SOC of approximately 0.45 upon departure at approximately 2:00 pm. Thus, as shown in FIG. 7a, there is a peak in discharging signals from approximately 11:30 am to about 2:00 pm. Because these vehicles are discharged, the adjusted demand 188 never exceeds the maximum allowed demand 186 despite the modified demand 190 significantly exceeding the maximum allowed demand 186 during this time period.

Around approximately 2:00 pm, which corresponds to time period 203 in FIGS. 7b and 7c, vehicles 210/230, 216/236 and 218/238 are continuously discharged until they each depart. From approximately 2:00 pm to 4:30 pm as shown in FIG. 7c, the relative departure probability is significantly higher for vehicle 216/236—ranging from approximately 0.8 to 0.9—than for vehicles 210/230 and 218/238. Therefore, the amount of power discharged for vehicle 216/236 is significantly higher than the discharge amount for vehicles 210/230 and 218/238, until vehicle 216/236 departs at approximately 4:30 pm. After 4:30 pm, the amount of power discharged for vehicles 210/230 and 218/238 is substantially increased until approximately 5:00 pm, where their SOCs level off to values of approximately 0.58 and 0.48, respectively.

As shown in FIG. 7a, the modified demand 190 is significantly higher than the maximum allowed demand 186 until shortly after 6:00 pm. Therefore, to ensure that the adjusted power demand 188 for the system does not exceed the maximum allowed demand 186, the discharging signals 182 for vehicles 210/230, 216/236 and 218/238 peak from about 2:00 pm to about 6:00 pm, with a very strong discharge signal at approximately 4:30 pm. Therefore, between about 2:00 pm and 6:00 pm, which corresponds to a portion of time period 203 in FIGS. 7b and 7c, the vehicle grid integration system sends discharging signals to the remaining vehicles 210, 216 and 218 to draw power from these vehicles and thereby shave peak power demand of the system.

As a result of the discharge signals sent to vehicles 210, 216 and 218 during this time, the modified demand 190 is significantly reduced such that the adjusted demand 188 of the system remains at or below the maximum allowed demand 186 as shown in FIG. 7a.

Therefore, the relative departure probabilities at various times, along with the vehicle SOC and predicted SOC upon departure, can be used to determine whether to charge or discharge one of the vehicles 208, 210, 212, 214, 216 and 218 at a given time. For example, if the determination of whether to charge or discharge is made at approximately 2:00 pm, the relative departure probability is very high for vehicle 216/236 and much lower for vehicles 210/230 and 218/238. Furthermore, the SOC of vehicle 216/236 is very high—nearly 0.8, whereas the SOC of vehicle 218/238 is lower—about 0.6. Thus, a determination is made to discharge a larger amount of power from vehicle 216/236 than from vehicle 218/238. However, after 4:30 pm, when vehicle 216/236 departs, the relative departure probabilities for vehicles 210/230 and 218/238 are nearly the same (about 0.5), but the current SOC is higher for vehicle 210/230, so more power is discharged from vehicle 210/230 than vehicle 218/238 from about 4:30 pm to about 6:00 pm, when the SOCs of those vehicles level off.

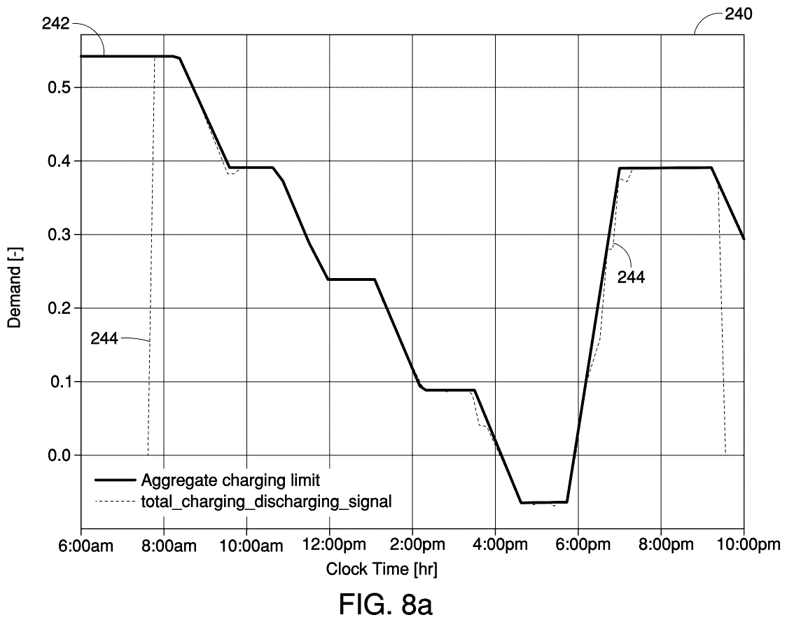

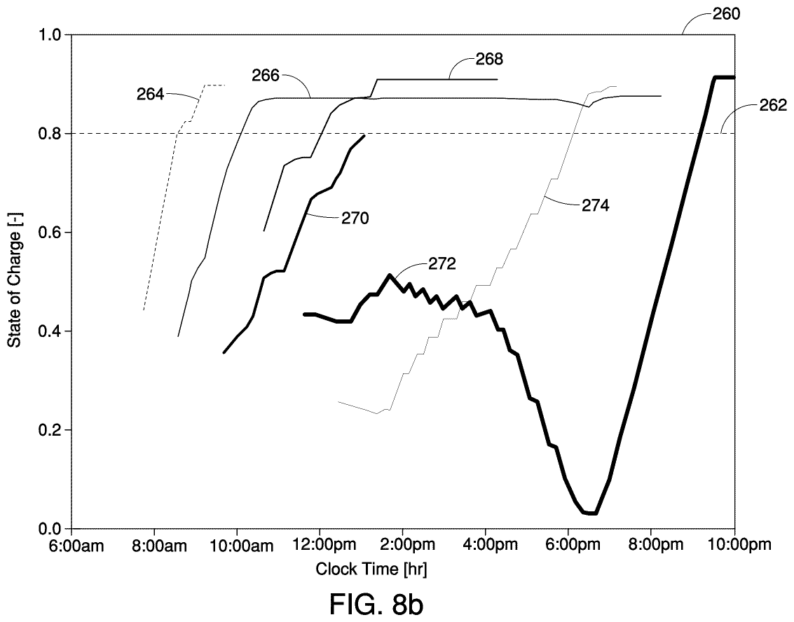

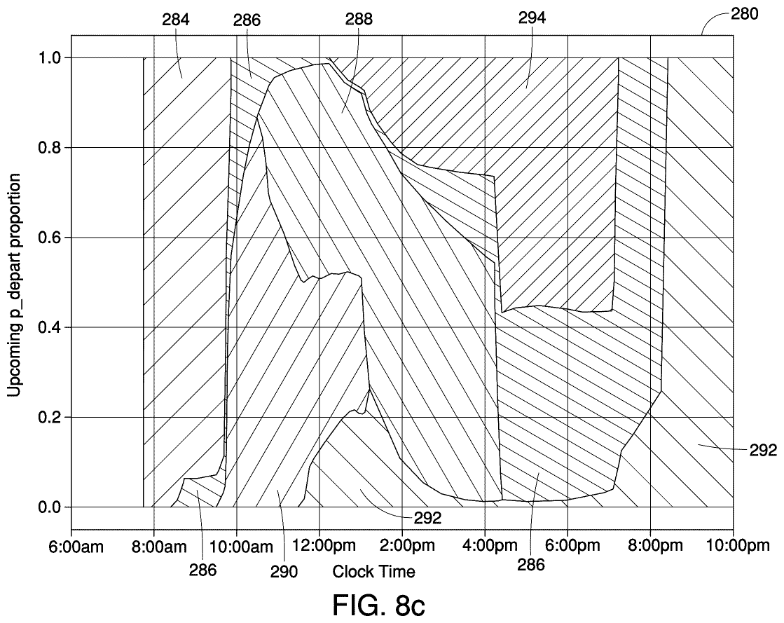

FIG. 8a is a chart 240 showing a power demand over time for a vehicle grid integration system according to an eighth embodiment. The vehicle grid integration system includes a demand source and a plurality of vehicles connected to the demand source. The demand source can be any suitable demand source connected to the power grid, such as a residential or commercial building, an industrial facility, a transportation system, an agricultural system, or another power demand source connected to the grid. Although this embodiment is directed to a system in which there is bidirectional charging, it should be understood that the vehicle grid system could alternatively be one in which there is unidirectional charging.

As shown in FIG. 8a, the line 242 represents the aggregate charging limit or peak demand of the vehicle demand integration system. Line 244 represents the total value of charging and discharging signals for the plurality of vehicles at the demand source.

As shown in FIG. 8a, the total value of discharging and charging signals 244 is 0.0 at approximately 7:00 am and significantly increases to the charging limit of 0.55 at approximately 7:30 am. The total value of discharging and charging signals 244 then gradually decreases to a value of −0.05 around approximately 4:30 pm. The total value of discharging and charging signals 244 remains the same until about 5:45 pm, when it significantly increases to just under 0.4. The total value of discharging and charging signals 244 for the vehicle grid integration system remains at or below the aggregate charging limit 242, indicating that peak shaving is successful.

FIG. 8b is a chart 260 showing the state of charge over time for the plurality of vehicles in the vehicle grid integration system according to the eighth embodiment. As shown in FIG. 8b, each of the vehicles 264, 266, 268, 270, 272 and 274 has a certain SOC when the vehicle arrives at the demand source. Line 262 represents the required departure SOC.

During a first time period, which starts at approximately 7:30 am and ends at approximately 11:30 am, vehicles 264, 266, 268 and 270 are all charged. At approximately 11:30 am, vehicle 264 has left the demand source, vehicle 266 has exceed the required SOC of 0.8 and is not being charged or discharged, and vehicles 268 and 270 have a SOC below the required SOC. As such, at 11:30 am, vehicle 272 arrives at the demand source with a relatively low SOC of 0.4. Therefore, vehicle 272 is discharged slightly until approximately 12:30 pm to 12:45 pm, when vehicle 270 reaches the required departure SOC of 0.8 and departs the demand source.

At approximately 12:00 pm, vehicle 274 arrives at the demand source with a SOC of approximately 0.25. From approximately 12:30 pm to 1:00 pm, vehicle 268 is charged to a final SOC of approximately 0.9, vehicle 272 is charged to an SOC of approximately 0.45, and vehicle 274 is discharged slightly to a SOC of approximately 0.23.

From approximately 2:00 pm to 6:30 pm, vehicle 272 is discharged and vehicle 274 is charged. Vehicle 274 is charged until it reaches a final SOC of approximately 0.9 and departs the demand source. From approximately 6:30 pm to 10:00 pm, when vehicle 272 is the only remaining vehicle, it is charged until it reaches a final SOC of about 0.9.

FIG. 8c is a chart 280 showing relative departure probabilities over time for the plurality of vehicles in the vehicle grid integration system according to the eighth embodiment. The relative departure probabilities for the vehicles range from 0.0 to 1.0, and the time ranges from 6:00 am to 10:00 pm in a single day. The relative departure probabilities for each of the vehicles 264, 266, 268, 270, 272 and 274 over time are represented by the shaded areas 284, 286, 288, 290, 292 and 294, respectively, in the chart 280.

As shown in FIGS. 8b and 8c, vehicle 264 (corresponding to area 284) arrives at the power demand source of the vehicle grid integration system around approximately 7:30 am. At approximately 8:30 am, vehicle 266/286 arrives, and the relative departure probability of vehicle 264/284 is approximately 0.9, whereas the relative departure probability of vehicle 266/286 is approximately 0.1. Between about 7:30 and 8:30 am, both vehicles 264 and 266 are charged as shown in FIG. 8b.

At approximately 9:30 am, vehicle 264/284 departs, and vehicle 270/290 arrives. At that time, vehicle 270/290 has the highest relative departure probability, approximately 0.58, and vehicle 266/286 has the lowest relative departure probability of approximately 0.42. From approximately 9:30 am to 10:30 am, both remaining vehicles 266 and 270 are charged as shown in FIG. 8b.

Vehicle 268/288 arrives at about 10:30 am, and from about 10:30 to 11:30 am, vehicles 268 and 270 are charged. Vehicle 272/292 arrives at about 11:30 am, and from 11:30 am to 12:30 pm, vehicles 268 and 270 are charged while vehicle 272 is discharged.

At approximately 12:00 pm, vehicle 270/290 has a much higher relative departure probability than vehicle 272/292. As such, at this time, the vehicle 270 is charged whereas the SOC of vehicle 272/292 remains approximately the same and, in fact, is discharged slightly. At this same time, vehicle 268/288 has the highest relative departure probability—nearly 0.50, but since its SOC is already over the required departure SOC of 0.8, its SOC remains the same until vehicle 270/290 departs at approximately 12:30 pm.

At approximately 12:00 pm, vehicle 274/294 arrives at the demand source. At approximately 12:30 pm to 12:45 pm, vehicle 270/290 departs. At that time, the relative departure probability of vehicle 268/288 is substantially higher than the other vehicles—about 0.6, whereas vehicles 272/292 and 274/294 have lower relative departure probabilities of about 0.25 and 0.18, and vehicle 266/286 has a very small relative departure probability.

From approximately 1:00 pm to 4:00 pm, when vehicle 268/288 departs, the relative departure probability of vehicle 268/288 is higher than the other vehicles. However, it is not charged because its SOC is already at approximately 0.9. Similarly, from approximately 4:00 pm to about 8:00 pm, when vehicle 266/286 departs, the relative departure probability of vehicle 266/286 is over 0.4, but it is not charged because its SOC is already above the required departure SOC of 0.8.

Instead, from approximately 1:00 pm to approximately 6:30 pm, only vehicles 272/292 and 274/294 are charged or discharged. In particular, around approximately 1:00 pm, the relative departure probability of vehicle 272/292 is 0.25 and is larger than the relative departure probability of vehicle 274/294, which is approximately 0.15. However, from about 2:00 pm to about 6:30 pm, when vehicle 274/294 departs, the relative departure probability of vehicle 274/294 is much greater—approximately 0.55—than the relative departure probability of vehicle 272/292—approximately 0.01. Therefore, during this time period, vehicle 274 is charged substantially from a SOC of about 0.25 to a final departure SOC of about 0.85, and vehicle 272 is discharged substantially from a SOC of about 0.45 to about 0.05. As such, once vehicle 266/286 departs at about 7:00 pm, vehicle 272/292 is rapidly charged to a final departure SOC of about 0.90 at 10:00 pm.

As shown in FIG. 8a, the total value of discharging and charging signals 244 significantly increases to the charging limit of 0.55 at approximately 7:30 am. This corresponds to the charging of vehicle 264. The total value of discharging and charging signals 244 then gradually decreases to a value of −0.05 around approximately 4:30 pm, when vehicle 272 is being discharged at a higher rate than vehicle 274 is being charged. The total value of discharging and charging signals 244 remains the same until about 5:45 pm, when it significantly increases to just under 0.4. This corresponds to the substantial charging of vehicle 272 to a final departure SOC of about 0.9. The total value of discharging and charging signals 244 for the vehicle grid integration system remains at or below the aggregate charging limit 242, indicating that peak shaving is successful.

Therefore, the relative departure probabilities at various times, along with the vehicle SOC and required SOC upon departure, can be used to determine whether to charge or discharge one of the vehicles 264, 266, 268, 270, 272 and 274 at a given time. In addition, other variables such as the battery temperature of vehicles 264, 266, 268, 270, 272 and 274 can also be used to determine the charge or discharge signal for those vehicles.

FIGS. 6a-8c demonstrate that a vehicle grid integration system according to the aforementioned embodiments can effectively shave peak power demand from the demand source while ensuring an adequate SOC for the vehicles upon departure, because the charging and discharging of the vehicles is based not only on the SOC or the peak demand of the demand source, but also the required SOC upon departure and the relative departure and/or arrival probabilities for each of the vehicles.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A system for managing at least one of charging and discharging of a plurality of vehicles interfacing with a demand source and a power grid, the system comprising:
at least one charging station configured to at least one of: supply power to and draw power from each of the plurality of vehicles at specified times; and
at least one controller configured to control at least one of charging and discharging of the plurality of vehicles by the at least one charging station at the specified times,
the at least one controller being configured to control the at least one of charging and discharging of the plurality of vehicles based on a power demand of the demand source, a state of charge of each of the plurality of vehicles at a first time, and at least one of a relative departure probability and a relative arrival probability of each of the plurality of vehicles.

2. The system according to claim 1, wherein
the at least one controller is a central processing unit in communication with the at least one charging station and each of the plurality of vehicles.

3. The system according to claim 1, wherein
the at least one controller is part of a remote server configured to communicate with the at least one charging station and each of the plurality of vehicles.

4. The system according to claim 1, wherein
the first time is an arrival time of each of the plurality of vehicles at the demand source or a current time.

5. The system according to claim 1, wherein
the at least one controller is further configured to control the at least one of charging and discharging of the plurality of vehicles based on a predicted state of charge required for each of the plurality of vehicles at an estimated departure time from the demand source.

6. The system according to claim 1, wherein
the at least one controller is further configured to control the at least one of charging and discharging of the plurality of vehicles based on a battery temperature of each of the plurality of vehicles.

7. The system according to claim 1, wherein
the power demand is directly detected or predicted using a model.

8. The system according to claim 1, wherein:
the relative departure probability of each of the plurality of vehicles is determined based on a first distribution of departure probabilities over time, and the relative arrival probability of each of the plurality of vehicles is determined based on a second distribution of arrival probabilities over time, and
at least one of the first distribution and the second distribution is determined by a machine learning model.

9. The system according to claim 8, wherein
the machine learning model is configured to update the at least one of the first distribution and the second distribution after a period of time has elapsed.

10. The system according to claim 8, wherein
the machine learning model is configured to determine the least one of the first distribution and the second distribution based on at least one of: historical information for the demand source and historical information for each of the plurality of vehicles.

11. The system according to claim 1, wherein
the at least one controller is configured to control the at least one of charging and discharging of the plurality of vehicles by dividing the plurality of vehicles into a charging group and a discharging group, normalizing charging signals for each of the plurality of vehicles in the charging group relative to other vehicles in the charging group, and normalizing discharging signals for each of the plurality of vehicles in the discharging group relative to other vehicles in the discharging group.

12. A method of managing at least one of charging and discharging of a plurality of vehicles interfacing with a demand source and a power grid, the method comprising:
providing a controller configured to control at least one of charging and discharging of the plurality of vehicles at specified times, and
controlling the at least one of charging and discharging of the plurality of vehicles using the controller based on a power demand of the demand source, a state of charge of each of the plurality of vehicles at a first time, and at least one of a relative departure probability and a relative arrival probability of each of the plurality of vehicles.

13. The method according to claim 12, further comprising
providing at least one charging station configured to supply power to each of the plurality of vehicles at the specified times.

14. The method according to claim 12, wherein
the controller is a central processing unit or a remote server in communication with the plurality of vehicles.

15. The method according to claim 12, wherein
the at least one of charging and discharging of the plurality of vehicles is controlled based on a predicted state of charge required for each of the plurality of vehicles at an estimated departure time from the demand source.

16. The method according to claim 12, further comprising
determining the power demand of the demand source by directly detecting the power demand or predicting the power demand using a model.

17. The method according to claim 12, further comprising:
determining the relative departure probability of each of the plurality of vehicles based on a first distribution of departure probabilities over time, and determining the relative arrival probability of each of the plurality of vehicles based on a second distribution of arrival probabilities over time,
at least one of the first distribution and the second distribution being determined using a machine learning model.

18. The method according to claim 17, wherein
the machine learning model is configured to update the at least one of the first distribution and the second distribution after a period of time has elapsed.

19. The method according to claim 17, wherein
the machine learning model is configured to determine the at least one of the first distribution and the second distribution based on at least one of: historical information for the demand source and historical information for each of the plurality of vehicles.

20. The method according to claim 12, wherein
the at least one of charging and discharging of the plurality of vehicles includes dividing the plurality of vehicles into a charging group and a discharging group, normalizing charging signals for each of the plurality of vehicles in the charging group relative to other vehicles in the charging group, and normalizing discharging signals for each of the plurality of vehicles in the discharging group relative to other vehicles in the discharging group.
